(19) United States
(12) Patent Application Publication
(10) Pub. No.: US 2024/0091972 A1
(43) Pub. Date: Mar. 21, 2024

(54) ROLL TO ROLL CAN COLLAR CONVERTING PROCESS

(71) Applicant: WestRock Packaging Systems, LLC, Atlanta, GA (US)

(72) Inventors: Gregory P. Hayter, Atlanta, GA (US); Matthew E. Zacherle, Chesterfield, VA (US); O. Larry Elliott, Richmond Hill, VA (US); Bradford J. Walling, Chesterfield, VA (US)

(21) Appl. No.: 17/766,466

(22) PCT Filed: Sep. 28, 2020
(86) PCT No.: PCT/US2020/053013

§ 371 Date: Apr. 4, 2022

Related U.S. Application Data
(60) Provisional application No. 62/909,313, filed on Oct. 2, 2019.

(51) Int. Cl. B26F 1/38; B26D 7/18; B65D 71/50

(52) U.S. Cl. CPC B26F 1/384; B26D 7/18; B65D 71/50; B65D 2571/0066

(57) ABSTRACT

A paperboard converting process is disclosed, which involves feeding a continuous roll of paperboard into a die-cutting station, die-cutting the continuous roll of paperboard into a continuous web of die-cut blanks, and re-winding the continuous web of die-cut blanks into a continuous roll of die-cut blanks downstream from the die-cutting station.

### BACKGROUND OF THE INVENTION

### 1. Field of the Invention

The subject invention is directed to packaging, and more particularly, to a method for converting a continuous roll of paperboard material into a continuous roll of die-cut can collar blanks for beverage containers.

### 2. Description of Related Art

In the field of packaging it is often required to provide consumers with a package consisting of multiple product containers, for example, aluminum beverage cans. The product containers may be held together within the package by an engagement device so that a group of containers can be selected and transported as a single unit. One such engagement device is formed from plastic and includes a series of linked rings, often referred to as yokes. These yokes or rings fit over the rimmed edges of a group of beverage cans.

There are disadvantages associated with using such plastic rings or yokes for grouping beverage cans. For example, the plastic material from which the yokes are made cannot be easily printed on to provide marketing, branding and promotional indicia. In order to provide an improvement in this field, multi-can engagement collars have been developed that are made from paperboard materials, which are more easily printed on.

Therefore, there is a need in the art for efficient high-speed, high volume processes for converting paperboard materials into printed multi-can engagement collars. The subject invention satisfies that need.

### SUMMARY OF THE DISCLOSURE

The subject invention is directed to a new and useful paperboard converting process, which includes the steps of feeding a continuous roll of paperboard into a die-cutting station, die-cutting the continuous roll of paperboard into a continuous web of die-cut blanks, and then re-winding the continuous web of die-cut blanks into a continuous roll of die-cut blanks downstream from the die-cutting station.

Preferably, the step of die-cutting the continuous roll of paperboard into blanks involves die-cutting side-by-side can collar blanks. The step of die-cutting the continuous roll of paperboard into blanks can involve die-cutting two-by-two side-by-side can collar blanks or two-by-three side-by-side can collar blanks. Alternatively, the step of die-cutting the continuous roll of paperboard into blanks could involve die cutting two three-by-two, side-by-side can collar blanks or three two-by-two, side-by-side can collar blanks.

The process also involves running nicks in the continuous roll of paperboard during the die-cutting step to maintain connectivity between adjacent die-cut blanks and to facilitate the subsequent separation of the die-cut blanks from one another in conjunction with a downstream can loading process.

In one embodiment of the invention, the step of die-cutting the continuous roll of paperboard into die-cut blanks involves in-line rotary die-cutting. In another embodiment of the invention, the step of die-cutting the continuous roll of paperboard into die-cut blanks involves in-line platen die-cutting. In the case of in-line platen die-cutting, the process would also include the additional steps of stripping out and removing any scrap material. In contrast, in the case of in-line rotary die-cutting, the bottom cylinder of the rotary die-cutter would handle the removal of scarp through a series of fingers, as known in the art.

It is envisioned that the step of feeding a continuous roll of paperboard into the die-cutting station involves feeding a continuous roll of pre-printed paperboard. Alternatively, the process can involve feeding the continuous roll of paperboard into a printing station upstream from the die-cutting station. It is also envisioned that the process could involve feeding the continuous roll of die-cut blanks into an automated packaging station. The package station could be in-line and downstream from the die-cutting station or it could be situated at a location that is remote from the die-cutting station.

These and other features of the paperboard converting process of the subject invention will become more readily apparent to those having ordinary skill in the art to which the subject invention appertains from the detailed description of the preferred embodiments taken in conjunction with the following brief description of the drawings.

### BRIEF DESCRIPTION OF THE DRAWINGS

So that those skilled in the art will readily understand how to perform the roll to roll can collar converting process of the subject invention without undue experimentation, preferred embodiments thereof will be described in detail herein below with reference to the figures wherein:

FIG. 1 is an illustration of a system for converting a continuous roll of paperboard into a continuous roll of die-cut can collar blanks in accordance with an embodiment of the subject invention, which involves in-line rotary die-cutting;

FIG. 2 is an illustration of a system for converting a continuous roll of paperboard into a continuous roll of die-cut can collar blanks in accordance with an embodiment of the subject invention, which involves in-line platen die-cutting; and

FIG. 3 is a flow chart illustrating the roll to roll converting process of the subject invention.

### DETAILED DESCRIPTION OF THE PREFERRED EMBODIMENTS

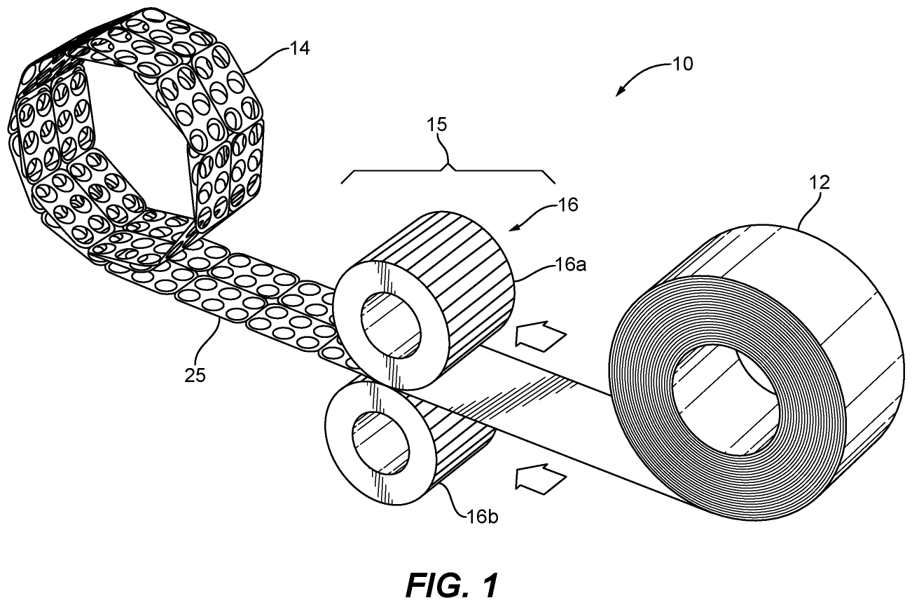

Referring now to the drawings, wherein like reference numerals identify similar structural elements and features of the subject invention, there is schematically illustrated in FIG. 1 a system 10 for converting a continuous roll of paperboard material 12 into a continuous roll of die-cut can collar blanks 14 in accordance with a preferred embodiment of the subject invention, which involves an in-line rotary die-cutter 16 having upper and lower die cylinders 16a, 16b. The converting system 10 is designed for a high speed, high volume converting process for printing, die-cutting and delivering a continuous roll of can collar blanks.

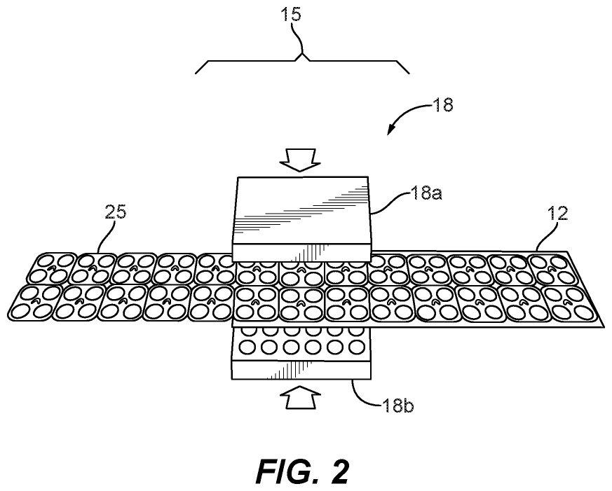

Alternatively, as illustrated in FIG. 2, the converting system 10 can include an in-line platen die-cutter 18 having upper and lower die plates 18a, 18b, instead of the rotary die-cutter 16 shown in FIG. 1. Those skilled in the art will readily appreciate that the configuration and/or dimensions of the die-cutter (16 or 18) utilized in converting system 10 can vary depending upon the dimensions of the paperboard material that is being processed thereby. For example, the paperboard material can have a roll width ranging from 22 inches to 26 inches or even greater.

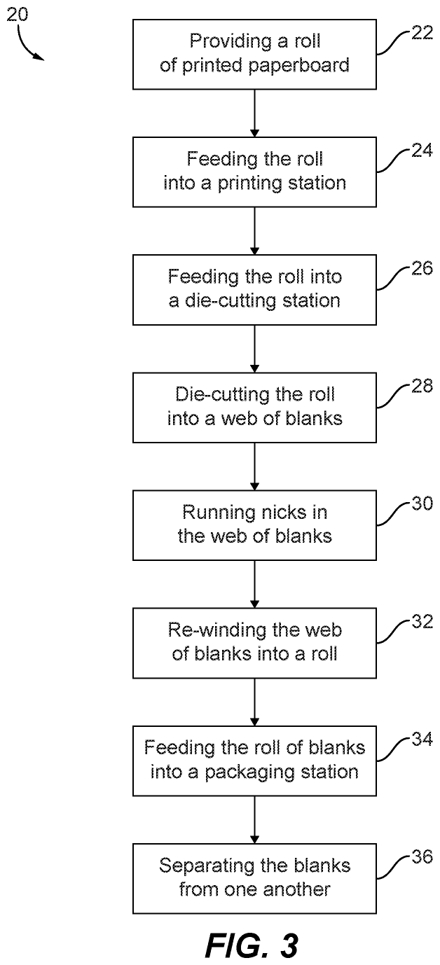

The subject invention is also directed to a new and useful paperboard converting process designated generally by reference numeral 20, which is described in FIG. 3. The converting process 20 includes the initial step 22 of providing a continuous roll of paperboard material 12. It is envisioned that the continuous roll of paperboard material 12 can be pre-printed with indicia (e.g., marketing, branding and/or promotional indicia). The paperboard material 12 could also be pre-printed with a can collar pattern, as shown for example in FIG. 2. Alternatively, the paperboard material 12 can be provided without printed indicia.

In the event the roll of paperboard material 12 is provided without printed indicia thereon, the converting process 20 could include the optional step 24 of feeding the continuous roll of paperboard material 12 into an in-line printing station, such as a station having a roll to roll flexographic printing machine or the like (not shown), where indicia is imprinted on at least one surface of the paperboard material 12.

The converting process 20 of the subject invention further includes the step 26 of feeding the continuous roll of paperboard material 12 (either printed or unprinted) into an in-line die-cutting station 15, which would include either a rotary die-cutter 16 as shown for example in FIG. 1, or a platen die-cutter 18 as shown for example in FIG. 2. At the die-cutting station 15, the process involves step 28 where the continuous roll of paperboard material 12 is die-cut into a continuous web of die-cut blanks 25, as depicted in FIGS. 1 and 2.

In the case of in-line platen die-cutting shown in FIG. 2, the process would also include the additional steps of stripping out and removing any scrap material from the in-line platen die cutter 18. More particularly, the die-cut web of paperboard material would be pulled forward and then the scrap material would be removed. In contrast, in the case of in-line rotary die-cutting shown in FIG. 1, the bottom cylinder 16b of the rotary die-cutter 16 would handle the removal of scrap material through a series of fingers, as known in the art.

Preferably, the step 28 of die-cutting the continuous roll of paperboard material 12 into blanks involves die-cutting side-by-side can collar blanks. More particularly, the step 28 of die-cutting the continuous roll of paperboard material 12 into blanks can involve die-cutting two-by-three, side-by-side can collar blanks for 6-packs of beverage containers, as depicted in FIG. 1. Alternatively, the step 28 of die-cutting the continuous roll of paperboard material 12 into blanks can involve die-cutting two-by-two, side-by-side can collar blanks for 4-packs of beverage containers, as depicted in FIG. 2. While not specifically shown in the figures, it is envisioned that the converting process 20 of the subject invention can be configured to provide two three-by-two, side-by-side can collar blanks or three two-by-two, side-by-side can collar blanks.

The converting process 20 also involves the step 30 of running nicks or perforations in the continuous roll of paperboard material 12 during or in conjunction with the die-cutting step 28 to maintain the connectivity between adjacent die-cut can collar blanks and facilitate the subsequent separation of the web of die-cut can collar blanks 25 from one another in conjunction with a downstream can loading process.

The converting process 20 further includes the step 32 of re-winding the continuous web of die-cut blanks 25 into a continuous roll of die-cut can collar blanks 14 downstream from the die-cutting station 15, as best seen in FIG. 1. Preferably, to assist in re-winding the web of die-cut collar blanks 25, a tensioning station (not shown) would be located after the die cutting station 15 and before the rewinding station, to tighten the blanks and prevent them from buckling or shingling as they are rewound. Thereafter, it is envisioned that the converting process 20 could involve the step 34 of feeding the continuous roll of die-cut blanks 14 into an automated packaging station (not shown).

The automated packaging station could be in-line and downstream from the die-cutting station 15 or it could be situated at a location that is remote from the die-cutting station 15. In addition, the converting process 20 can involve the step 36 of separating of the web of die-cut can collar blanks 25 from one another, preferably at relatively high speeds. It is envisioned that the web of die-cut can collar blanks 25 could be separated from one another before or after they are engaged with a group of beverage containers.

While the converting process of the subject disclosure has been shown and described with respect to certain preferred embodiments, those skilled in the art will readily appreciate that changes and/or modifications may be made thereto without departing from the scope of the subject disclosure.

What is claimed is:

1. A paperboard converting process, comprising:
a) feeding a continuous roll of paperboard into a die-cutting station;
b) die-cutting the continuous roll of paperboard into a continuous web of die-cut blanks; and
c) re-winding the continuous web of die-cut blanks into a continuous roll of die-cut blanks downstream from the die-cutting station.

2. A converting process as recited in claim 1, wherein the step of die-cutting the continuous roll of paperboard into blanks involves die-cutting side-by-side can collar blanks.

3. A converting process as recited in claim 2, wherein the step of die-cutting the continuous roll of paperboard into blanks involves die-cutting two-by-two side-by-side can collar blanks.

4. A converting process as recited in claim 2, wherein the step of die-cutting the continuous roll of paperboard into blanks involves die-cutting two-by-three side-by-side can collar blanks.

5. A converting process as recited in claim 2, further comprising running nicks in the continuous roll of paperboard to facilitate separation of the die-cut blanks from one another.

6. A converting process as recited in claim 1, wherein the step of die-cutting the continuous roll of paperboard into die-cut blanks involves in-line rotary die-cutting.

7. A converting process as recited in claim 1, wherein the step of die-cutting the continuous roll of paperboard into die-cut blanks involves in-line platen die-cutting.

8. A converting process as recited in claim 7, wherein the step of die-cutting the continuous roll of paperboard into die-cut blanks involving in-line platen die-cutting includes the additional steps of stripping out and removing any scrap material.

9. A converting process as recited in claim 1, wherein the step of feeding a continuous roll of paperboard into a die-cutting station involves feeding a continuous roll of pre-printed paperboard.

10. A converting process as recited in claim 1, further comprising feeding the continuous roll of paperboard into a printing station upstream from the die-cutting station.

11. A converting process as recited in claim 1, further comprising feeding the continuous roll of die-cut blanks into a packaging station.

12. A converting process as recited in claim 11, further comprising separating the die-cut can collar blanks from one another.

13. A paperboard converting process, comprising:
a) providing a continuous roll of printed paperboard;
b) feeding the continuous roll of printed paperboard into a die-cutter;
c) die-cutting the continuous roll of paperboard into a continuous web of die-cut can collar blanks; and
d) re-winding the continuous web of die-cut can collar blanks into a continuous roll of die-cut can collar blanks downstream from the die-cutting station.

14. A converting process as recited in claim 13, wherein the step of die-cutting the continuous roll of printed paperboard into can collar blanks involves die-cutting side-by-side can collar blanks.

15. A converting process as recited in claim 14, wherein the step of die-cutting the continuous roll of paperboard into blanks involves die-cutting two-by-two side-by-side can collar blanks.

16. A converting process as recited in claim 14, wherein the step of die-cutting the continuous roll of paperboard into blanks involves die-cutting two-by-three side-by-side can collar blanks.

17. A converting process as recited in claim 14, further comprising running nicks in the continuous roll of paperboard to facilitate separation of the die-cut can collar blanks from one another.

18. A converting process as recited in claim 14, wherein the step of die-cutting the continuous roll of printed paperboard into die-cut can collar blanks involves in-line rotary die-cutting.

19. A converting process as recited in claim 13, wherein the step of die-cutting the continuous roll of printed paperboard into die-cut can collar blanks involves in-line platen die-cutting.

20. A converting process as recited in claim 19, wherein the step of die-cutting the continuous roll of paperboard into die-cut blanks involving in-line platen die-cutting includes the additional steps of stripping out and removing any scrap material.

21. A converting process as recited in claim 13, further comprising feeding the continuous roll of die-cut can collar blanks into a packaging station.

22. A converting process as recited in claim 21, further comprising separating the die-cut can collar blanks from one another.
